(19) United States
(12) Patent Application Publication
(10) Pub. No.: US 2008/0148611 A1
(43) Pub. Date: Jun. 26, 2008

(54) Protective cover

(76) Inventor: Ian Andrew Cheetham, Dronfield (GB)

Correspondence Address: JAMES C. WRAY, 1493 CHAIN BRIDGE ROAD, SUITE 300, MCLEAN, VA, 22101, US

(21) Appl. No.: 11/644,413

(22) Filed: Dec. 22, 2006

(51) Int. Cl. G09F 7/00

(52) U.S. Cl. 40/584

(57) ABSTRACT

A protective cover located on laths of a security shutter. The cover comprises a set of strips of material, and each strip comprises a base layer and a transparent protective layer. The base layer has a first surface fixed against a lath of the shutter and an image on an opposing second surface. The transparent protective layer covers the second surface such that the image is visible through the transparent layer.

### TECHNICAL FIELD

The present invention relates to: a protective cover located on laths of a security shutter; a method of producing a covering for a security shutter; and a method of advertising.

### BACKGROUND OF THE INVENTION

Security shutters are used to provide protection for windows and doors of buildings and to prevent access to such buildings. Such a shutter comprises a number of hinged laths configured to roll up into a housing when not required. Typically the shutter is formed of steel, that is painted to provide protection to corrosion.

Such shutters are often lowered when the building is unattended, for example at night, and provides a surface that often attracts unwanted graffiti. The graffiti may in some cases be removed, but typically the paint itself is adversely affected by solvents used to remove the graffiti.

### BRIEF SUMMARY OF THE INVENTION

According to first aspect of the present invention, there is provided a protective cover located on laths of a security shutter, said cover comprising a set of strips of material, and each strip comprising: a base layer having a first surface fixed against a lath of said shutter and an image on an opposing second surface; and a transparent protective layer covering said second surface such that said image is visible through said transparent layer.

According to second aspect of the present invention, there is provided a method of producing a covering for a security shutter comprising a plurality of laths, said method comprising the steps of: obtaining an image; determining parameters of a security shutter to be covered; printing said image on a base layer; covering said base layer with a transparent protective layer to form a laminate; and cutting through said laminate to form a set of strips each having length and width determined from said parameters.

According to third aspect of the present invention, there is provided a method of advertising, comprising the steps of: offering advertising space on a security shutter of a building; obtaining an image relating to a required advertisement; determining dimensions of said shutter; printing an image onto a sheet; cutting said sheet into strips, in dependence upon said dimensions, such that said image is split into portions; and applying said strips to said shutter to form an advertisement.

### BRIEF DESCRIPTION OF THE SEVERAL VIEWS OF THE DRAWINGS

FIG. 1 shows a security roller-shutter 101 of known type located on a building 102;

FIG. 2 shows the shutter 101 raised to provide access to the building 102;

FIG. 3 shows a flow chart providing an overview of a method of producing a protective cover for a shutter, such as shutter 101;

FIG. 4 illustrates three parameters of a shutter determined when manufacturing a protective cover;

FIG. 5 shows three printed bands 501, 502 and 503 on corresponding lengths base layer material 504, 505 and 506;

FIG. 6 illustrates the process of attaching a protective layer 601 to the printed base layer 504;

FIG. 7 shows a cross-section of a sample of the shutter-cover material 604;

FIG. 8 illustrates the process of cutting the printed bands (such as band 501) into strips 801;

FIG. 9 shows the protective cover 901 for the security shutter 101;

FIG. 10 shows a flow chart providing an overview of a method of attaching the cover 901 to the shutter 101;

FIG. 11 shows the step 1004 of FIG. 10 of applying the strips 801 of material 604;

FIG. 12 shows a method of heating the strips 801 on the shutter 101, at step 1007 of FIG. 10;

FIG. 13 shows the shop 102 with the shutter rolled down, after application of the protective cover 901; and

FIG. 14 shows the shop 102 after removal of cover 901 and attachment of a new cover 1401 to the shutter 101.

### DESCRIPTION OF THE BEST MODE FOR CARRYING OUT THE INVENTION

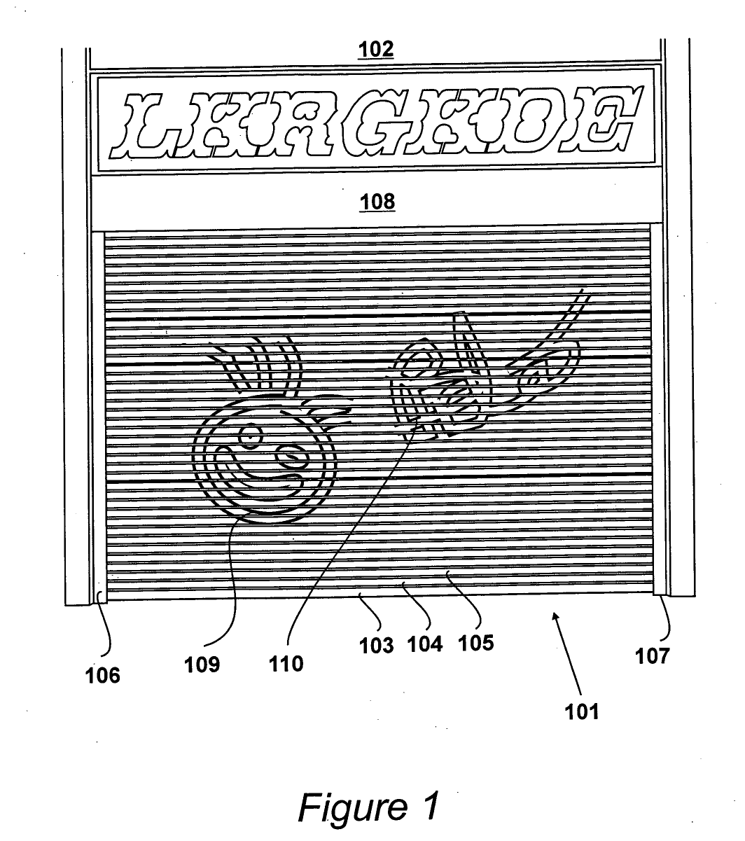

### FIG. 1

A security roller-shutter 101 of known type is shown in FIG. 1 located on a building 102. The shutter comprises steel laths such as laths 103, 104 and 105 that are hinged together and supported by guides 106 and 107. The shutter has a housing 108 in which the shutter may be rolled when not required.

The laths of the shutter in the present example have a flat outer surface but other shutters have a curved surface to provide additional strength and rigidity.

In FIG. 1, the shutter has been lowered to provide protection for the building's windows and doors, and also to prevent access into the building. However, as is known to occur, the shutter 101 itself has been defaced by graffiti 109 and 110.

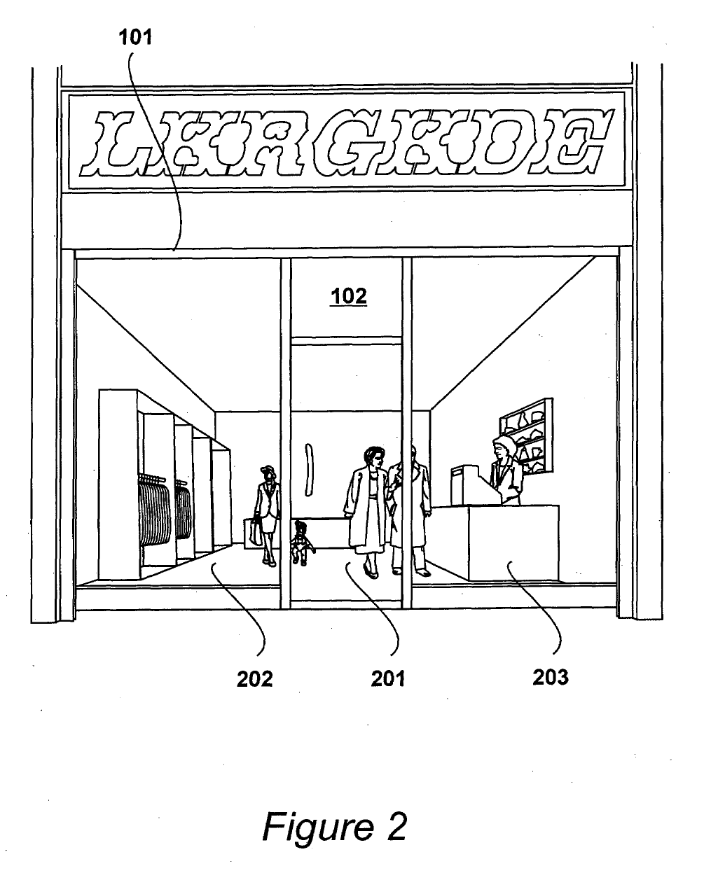

### FIG. 2

The shutter 101 is shown raised in FIG. 2 to provide access to the building 102. In the present example, the building 102 is a shop, and the raised shutter allows access to a glass door 201, as well as allowing passers-by to see through the shop windows 202 and 203.

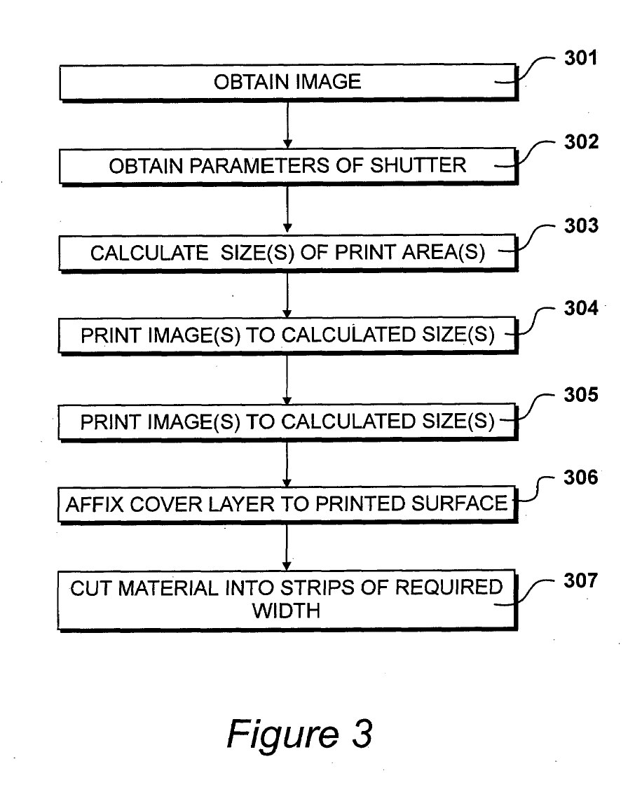

### FIG. 3

A method of producing a protective cover for a shutter, such as shutter 101, is illustrated by FIGS. 3, 4, 5, 6, 7 and 8. A flow chart providing an overview of the method is shown in FIG. 3.

At step 301 of the method, an image is obtained that is to be presented by the shutter. In the present example, the shutter is to present an image of the interior of the shop itself, and consequently at step 301 a digital photograph of the shop is taken. In order to achieve the required definition in the final image, the photograph is taken using a camera capable of producing images having between 40 and 60 megapixels. To achieve a clear image of the shop's interior, the photograph is taken when external illumination is reduced, for example at dusk or at night, when the shop's internal lights are switched on.

After taking the photograph, the image may be enhanced using known computer software, and if required the pixel count is increased to avoid pixels becoming obvious in the image of the finished product. For example, for an image of 4 metres wide by 3 metres high, 300-megapixel images have been found to provide a satisfactory result.

The image file representing the image is required for use in a later printing stage of the process, and may be transported on the camera to a computer that is local to the printing equipment. Alternatively, the file may 10 be loaded onto a computer and saved to a computer readable medium such as a CD-ROM before transporting, for example by mail. As a further alternative the image is loaded onto a client computer and then electronically transported over the internet, for example by uploading to a second computer (a server) using file transfer protocol (FTP). The latter method allows the photographer to provide the image to the printer over long distances with only little delay.

As an alternative to obtaining the image by photography, the image may be, for example, obtained from an existing collection of stored images, or generated using graphics software on a computer.

The second step 302 in the process is to obtain parameters of the shutter. The laths of the shutter have a visible surface area extending between the hinge mechanisms that may be covered without preventing the shutter from being correctly rolled up. The parameters that are obtained comprise of the length 401 of the laths of the shutter that is viewable, the width 402 (i.e. height) of the area of the laths to be covered, the width 403 of the gap between the areas of the laths to be covered, the overall height of the shutter and the number of laths that are visible when the shutter is fully lowered.

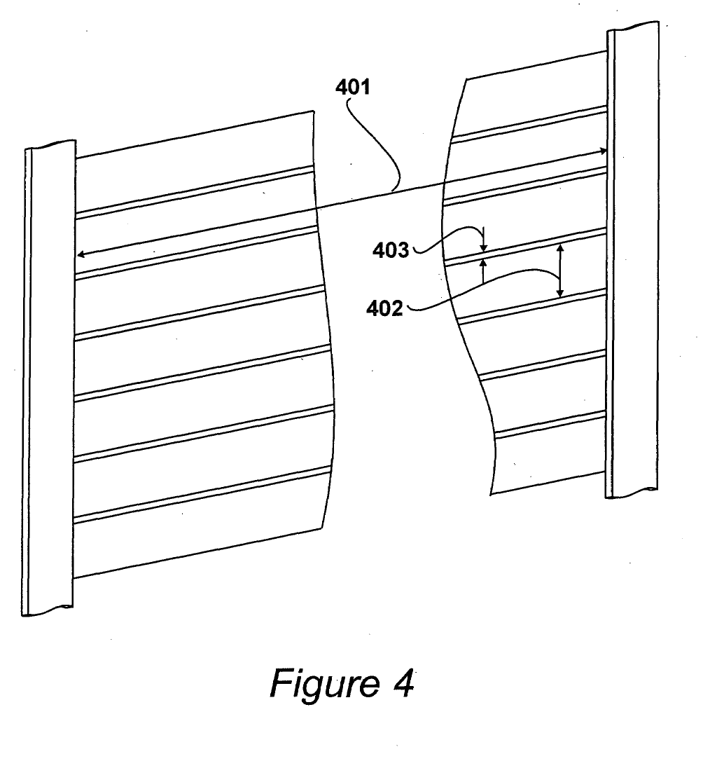

### FIG. 4

The first three of these parameters determined at step 302 are illustrated in FIG. 4.

In the case of a shutter having curved laths, the cover extends around a curved surface. Consequently, the width 402 is actually a distance along a generally upward line extending around the curved surface of the lath.

All of the parameters may be obtained by measurement of the shutter itself. However, if the type of shutter is identifiable then the widths 402 and 403 may be obtained from previous records for that type of shutter.

For most shutters, it is possible to print the whole image onto a single sheet of material. For example, the image may be printed on to a sheet of material 4 or 5 metres wide. However, in the present example, the image is printed in several bands, so that a narrower material (having a width of 1 metre) may be used as the printing substrate. Consequently, at step 304 (of FIG. 3), the height of each of these bands is calculated.

As will be described below, each of the bands is used to cover an integer number of the laths of the shutter, and therefore the bands are arranged to have a width equal to an integer number of the lath widths 402 and gap widths 403. For example, if the overall height of the viewable area of the shutter includes 44 laths and the image is to be printed in three bands, the bands are printed with width in the ratio 15:15:14.

The bands of image having the sizes calculated at step 304 are then printed at step 305.

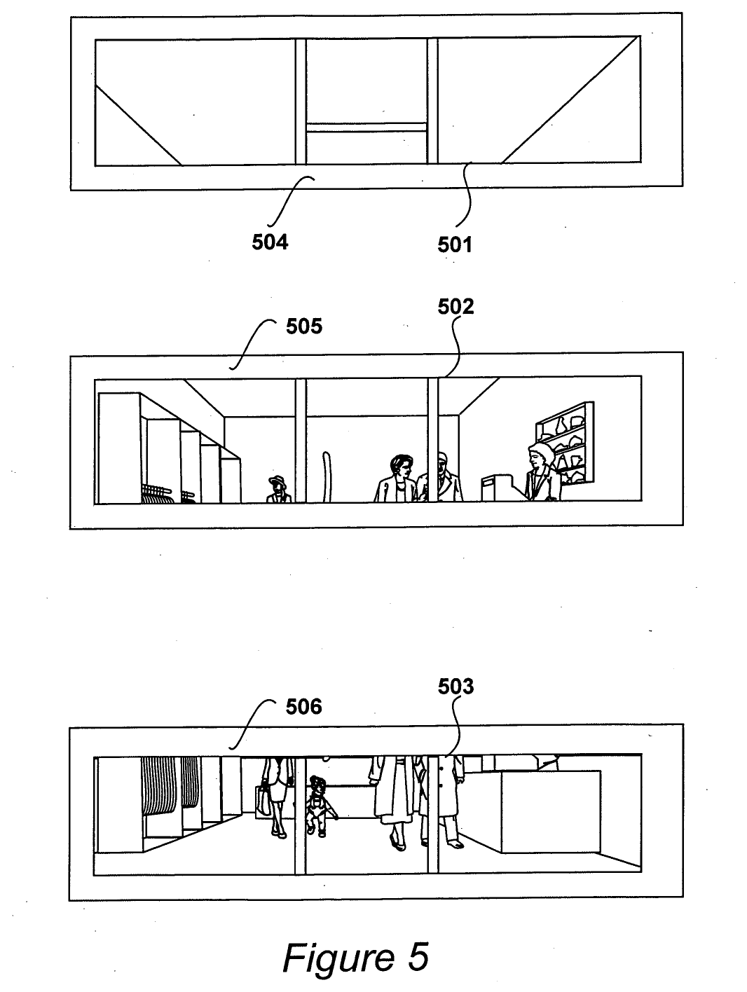

### FIG. 5

The three printed bands 501, 502 and 503 of the present example are shown in FIG. 5 on corresponding lengths of 1 metre wide base layer 504, 505 and 506. The base layer material is self-adhesive PVC (polyvinyl chloride) sheet. More specifically, it is an intermediate grade monomeric calendered self-adhesive vinyl suitable for receiving solvent inks. In the present example, it is Metamark MD3, and of which information is available at www.metamark.co.uk.

Printing is performed on suitable printing equipment using color fast solvent inks. For example, a Scitex XL inkjet machine as produced by Hewlet-Packard may be used, along with Scitex inks.

As may be seen in FIG. 5, the image of the shop has been horizontally divided into three parts such that assembly of the parts, one above the other, would reconstitute the image.

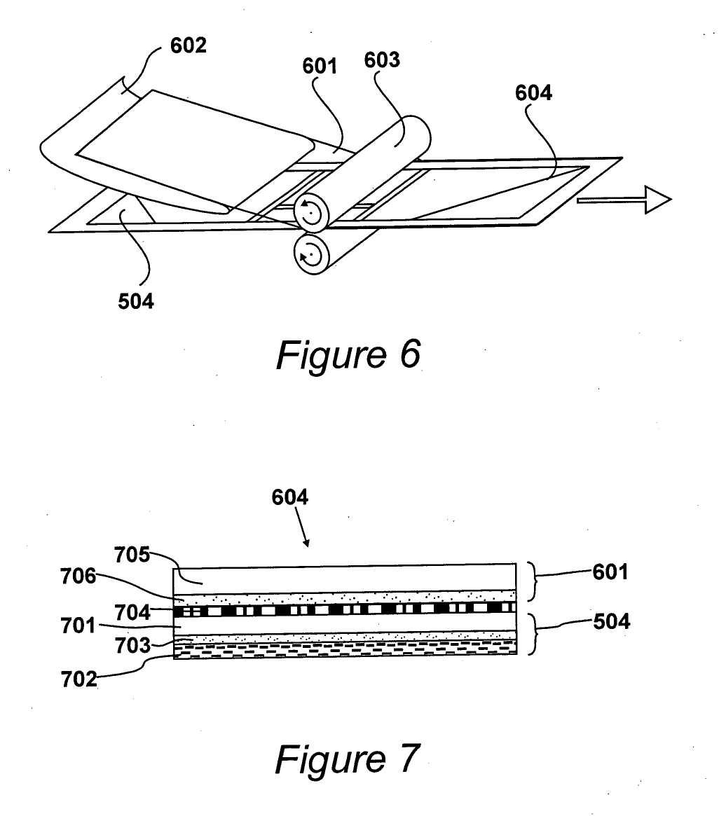

### FIG. 6

Following printing at step 305, a protective layer is fixed to the printed surface of the base layer 504, 505, 506 at step 306 (shown on FIG. 3).

The process of attaching a protective layer 601 to the printed base layer 504 is illustrated in FIG. 6. The protective layer 601 is a sheet of a transparent polymer, and in the present case comprises a self-adhesive PVC (polyvinyl chloride) sheet. The layer 601 is supplied on a release paper 602 that is removed as the protective layer is applied to the printed surface of the material 504. An example of a suitable self adhesive material 601 is Protac Emerytex UV 125 μ as supplied by Drytac of Richmond, Va., USA.

The protective layer 601 and base layer 504 are assembled together by passing between heated rollers 603 having a temperature of approximately 49° C., to produce shutter-cover material 604.

### FIG. 7

A cross-section of a sample of the shutter-cover material 604 is shown in FIG. 7. The material comprises the base layer 504 and the protective layer 601 laminated together. Thus, the shutter-cover material comprises the PVC layer 701 of the base material 504 separated from its release paper 702 by a layer of permanent clear pressure sensitive solvent-based acrylic adhesive 703. The opposite surface of the PVC layer 701 supports a layer of printed ink 704. The clear PVC film 705 of the protective layer 601 is attached to the printed surface by its solvent acrylic adhesive 706.

As well as the print layer 704 comprising color-fast inks that are resistant to fading under light, the protective layer 601 contains U.V. stabilisers which provide the inks with protection from ultraviolet.

Returning to FIG. 3, the final step to produce the protective cover for a shutter is to cut the printed bands 501, 502.and 503 into strips, so that each strip is the width 402 of the area of the laths to be covered (determined at step 302).

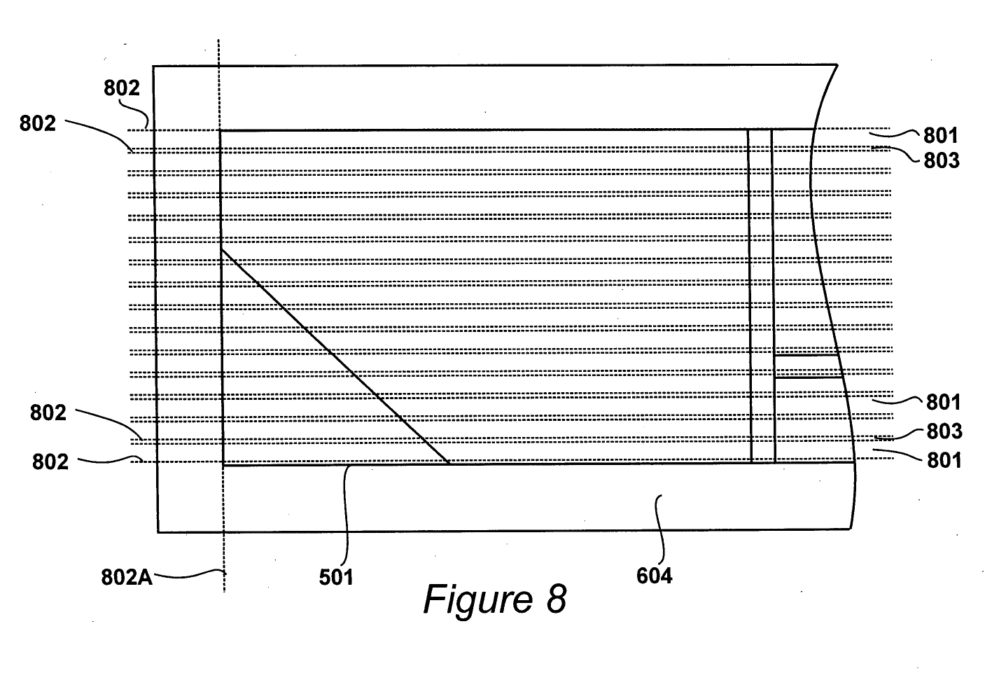

### FIG. 8

The process of cutting the printed bands (such as band 501) into strips 801 is illustrated in FIG. 8, where dashed lines 802 represent lines along which the material 604 is cut. The material 604 is cut using a flatbed cutting machine capable of providing the cut strips 801 with clean straight edges. For example, cutting may be performed using a flatbed cutting machine as produced by Zund.

Firstly, the ends of the printed bands are trimmed by cuts 802a to the length 401 of the laths of the shutter that is viewable, as determined at step 302. Then, the printed bands 504, 505, 506 are cut along their length to produce the strips 801 separated by waste strips 803. The strips 801 are arranged to have a width equal to the width 402 of the area of the laths to be covered, as determined at step 302. Similarly, the waste strips 803 have a width equal to the width 403 of the gap between the areas of the laths to be covered. The waste strips 803 are not required, and are subsequently disposed of. However, the set of strips of material 801 represent the finished protective cover for the security shutter 101.

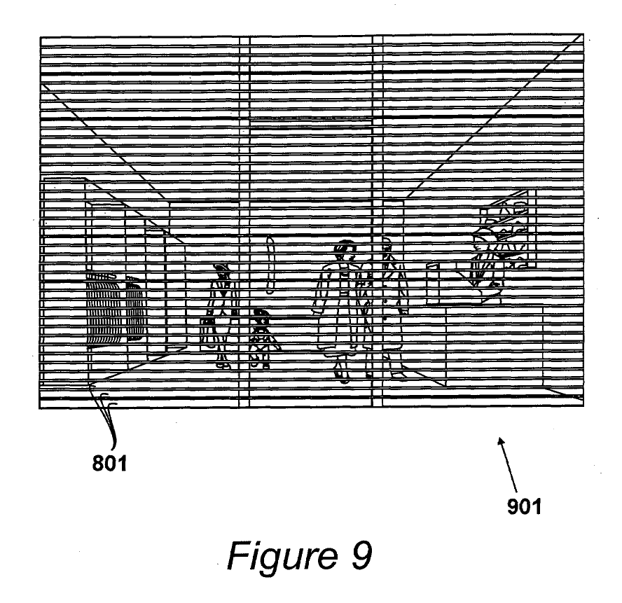

### FIG. 9

The protective cover 901 for the security shutter 101 is shown in FIG. 9. As will now be understood, the cover 901 comprises a set of strips 801 of material, and each strip comprises a base layer having adhesive for fixing against a lath of the shutter, and printed image layer covered by a transparent protective layer so that the image is visible through the transparent layer.

As shown in FIG. 9, the strips 801 may be assembled one above the other so that the image on each strip forms part of a larger image.

The strips 801 are each rolled up, labelled with an indication of their position in the series of strips and boxed for transportation to the shutter 101 where they are to be used.

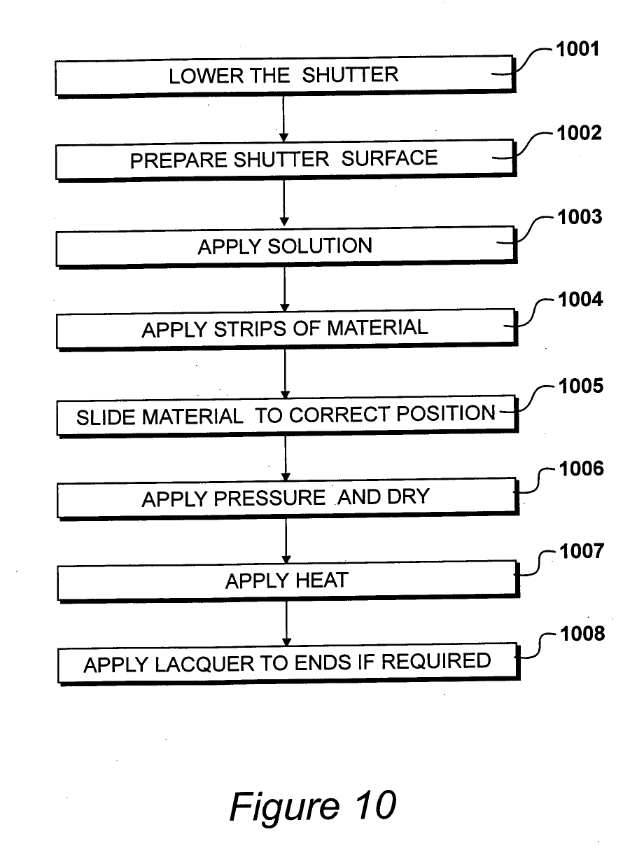

### FIGS. 10, 11 and 12

A method of applying the strips 801 of material 604 to the shutter 101 is illustrated by FIGS. 10, 11 and 12. A flow chart providing an overview of the method is shown in FIG. 10.

If it is rolled up, the shutter 101 is fully lowered at step 1001. The surface of the shutter that is to be coated is then prepared at step 1002. Step 1002 comprises cleaning the surface by, for example, using steam cleaning equipment. In addition, if the surface of the shutter is a type that is known to be difficult to stick to, the surface is also primed using a spray adhesive of the type normally used for adhering carpets to a floor surface.

At step 1003 a weak detergent solution is applied to the shutter surface, before the strips 801 of material 604 are applied at step 1004.

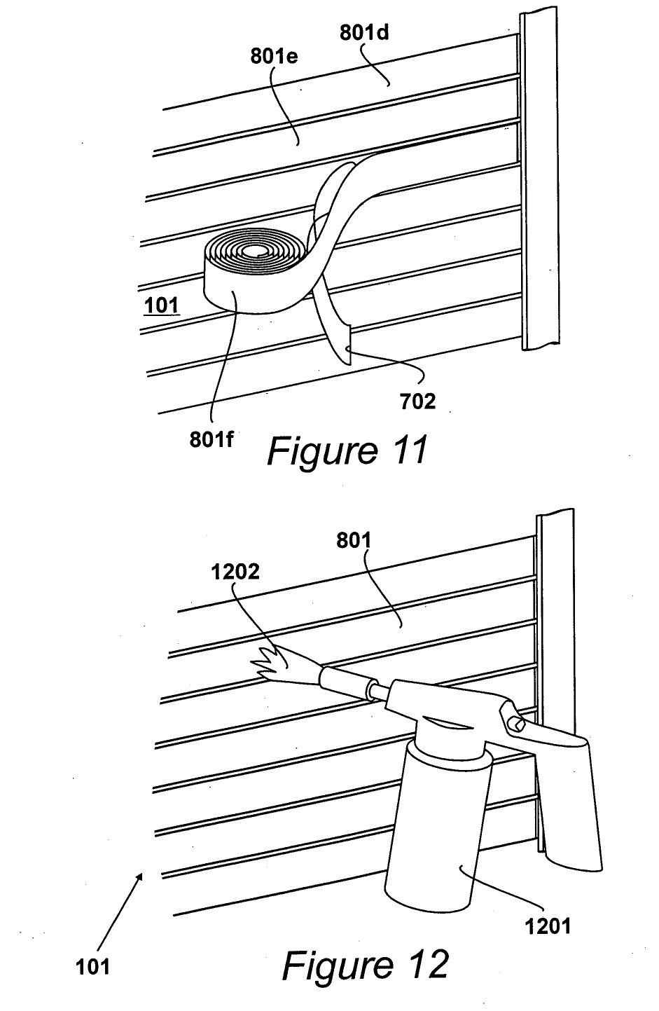

The step 1004 of applying the strips 801 of material 604 is illustrated by FIG. 11. In the present example, the strips 801 are being applied starting from the highest lath of the shutter to the lowest. Thus, in FIG. 11 several strips including 801d and 801e have been applied already and a strip 801f is currently being applied.

To apply a strip, such as 801f, the release paper 702 is pealed from an end portion of the strip, and that end portion is manually located against the next lath in the series. The release paper is then pealed away while the exposed adhesive layer 703 is manually pressed against the lath.

Although alignment of the strips should be attempted during the application at step 1004, the alignment is improved at step 1005 where the strips are manually slid around. Sliding of the strips is possible due to the previously applied detergent solution which provides the necessary lubrication. As the detergent solution is only required for this purpose, it should only contain sufficient detergent to allow such sliding.

Clearly, although steps 1004 and 1005 have been illustrated as successive steps, in reality they may be integrated.

Once the strips 801 are correctly positioned, pressure is applied to squeeze out excess water and air bubbles. This may be achieved using a felt pad cut to a profile that complements the contour of the lath. Thus a concave curved pad is used to apply pressure along a convex curved lath.

Heat is then applied at step 1007, to drive out residual moisture and air trapped under the strips 801, and to activate the adhesive layer 703. This may be achieved using an electric hot-air gun, for example of the type used to strip paint. The hot air from the gun is directed to, and moved along, each strip in turn.

Another method of heating the strips 801 on the shutter 101, at step 1007, is shown in FIG. 12. A propane gas torch 1201 provides a flame 1202 that is held close to, and moved along, each of the strips. Unlike-the hot-air gun, the torch 1201 has the advantage of not requiring access to an electricity supply. This is particularly relevant when the strips 801 are applied to a shutter of a building that has already been closed and locked, leaving no access to a mains electricity supply

Raising the temperature of the adhesive layer 703 improves the initial adhesion of the strips 801 to the shutter 101. However, with either the hot-air gun or the gas torch, prolonged heating at any one position of the strips has to be avoided to prevent damage to the material. For example, in the case of the materials used in the present embodiment, temperatures are kept below 95° C.

The adhesive 702 has an adhesion that improves with age. Consequently, if necessary, a lacquer is applied along the short ends of the strips 801, at step 1008, to provide protection against tampering by vandals.

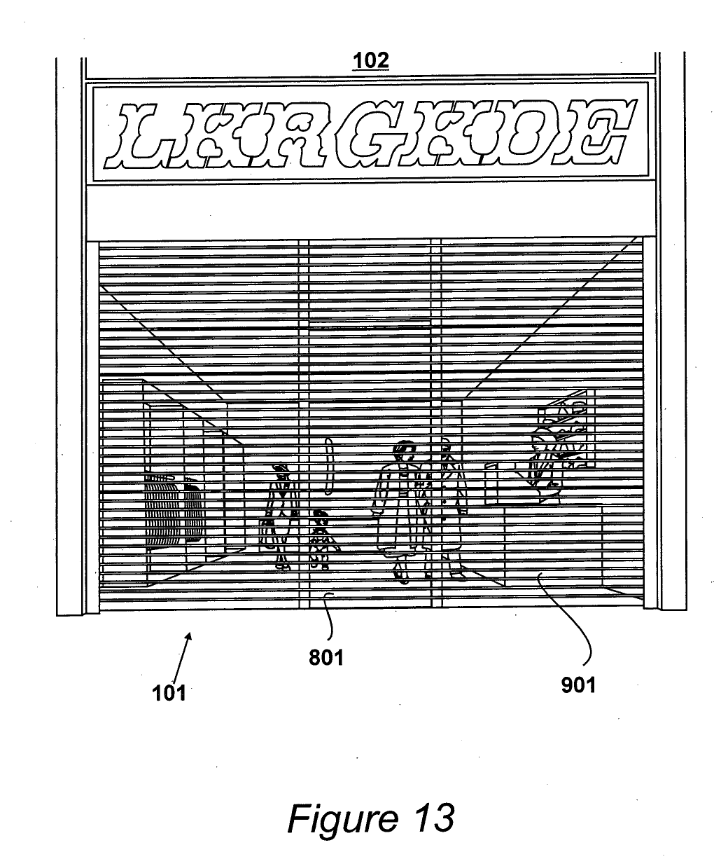

### FIG. 13

The shop 102 is shown with the shutter down in FIG. 13 after application of the protective cover 901. Consequently, the cover 901 provides an image showing the interior of the shop when it is open.

The protective layer 601 of the cover 901 may be cleaned with strong acting solvents, such as cellulose thinners, without being adversely affected. Furthermore, the protective layer 601 protects the image layer 704 of the cover 901 from attack by such solvents. Consequently, if graffiti is applied to the cover 901, it may be removed without affecting the cover or the image it provides.

In addition, cover 901 also provides the shutter with a degree of protection from mechanic attack by vandals. Similarly, the protective layer 601 provides the image layer of the cover 901 with a degree of protection from mechanical attack, and from normal abrasion produced by operation of the shutter.

When the cover 901 is to be replaced, this is achieved by pealing off each strip 801 while heating with, for example, a hot-air gun or propane gas torch.

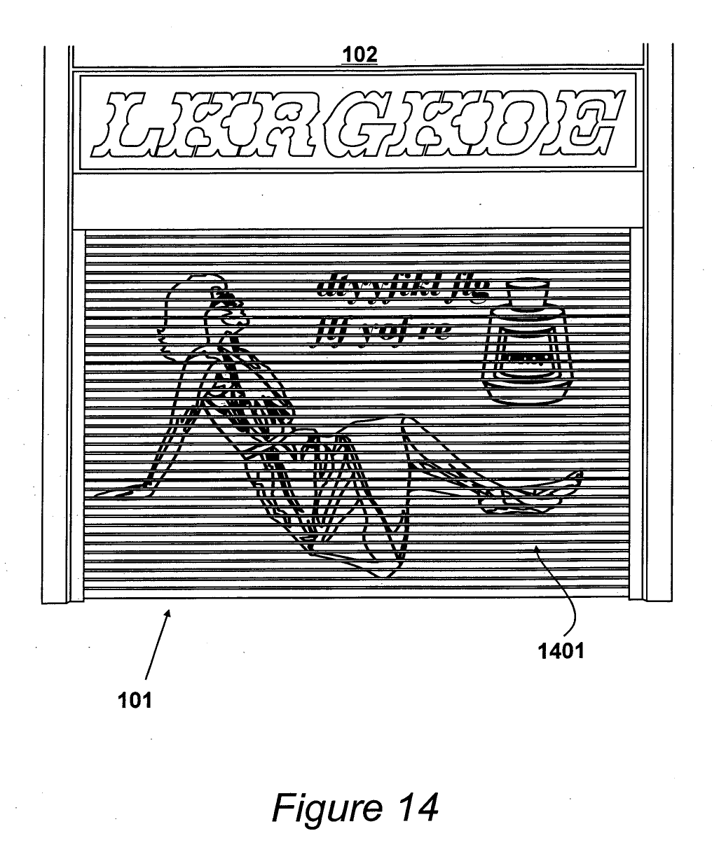

### FIG. 14

The shop 102 is shown again in FIG. 14 after removal of cover 901 and attachment of a new cover 1401 to the shutter 101. The cover 1401 is substantially the same as cover 901 but includes an image layer that provides an advertisement of a product, illustrated at 1402. Thus, as well as providing protection to the security shutter 101, the cover 1401 also makes the shutter a useful advertising space. Also, as the cover 1401 is easily removable and so can be replaced, the advertising space may be offered for finite periods of time.

Thus, the owner of the shop 102 is able to offer advertising on the security shutter 101 for finite periods of time, in exchange for a payment relating to that period. When the offer is accepted, an electronic image file relating to the advertisement is obtained, and a new cover is produced using the method as described above with respect to FIGS. 3 to 8, but using the image file of the advertisement. The strips of the new cover are then applied to the shutter as described with respect to FIG. 10 to 12 to form an advertisement, such as that shown in FIG. 14.

This method of advertising could also be performed using a cover that does not have the protective layer 601. The cover would not be as robust as the cover 1401, or provide protection to its image against graffiti, weathering, etc. However, where an advertisement is only intended to be placed on the shutter for short period of time, a cover without a protective layer 601 may provide a more economic alternative.

1. A protective cover located on laths of a security shutter, said cover comprising a set of strips of material, and each strip comprising:
a base layer having a first surface fixed against a lath of said shutter and an image on an opposing second surface; and
a transparent protective layer covering said second surface such that said image is visible through said transparent layer.

2. A protective cover according to claim 1, wherein said protective layer contains ultraviolet (U.V.) stabilisers which provide protection to said image.

3. A protective cover according to claim 1, wherein said protective layer comprises polyvinyl chloride (PVC).

4. A protective cover according to claim 1, wherein said base layer and said protective layer are fixed together by an acrylic adhesive layer.

5. A protective cover according to claim 1, wherein said images of said strips form components of a larger image.

6. A protective cover according to claim 1, wherein said larger image relates to advertising of a product or service.

7. A protective cover according to claim 1, wherein said base layer is fixed against said lath by an acrylic adhesive.

8. A method of producing a covering for a security shutter comprising a plurality of laths, said method comprising the steps of:
obtaining an image;
determining parameters of a security shutter to be covered;
printing said image on a base layer;
covering said base layer with a transparent protective layer to form a laminate; and
cutting through said laminate to form a set of strips each having length and width determined from said parameters.

9. A method of producing a covering for a security shutter according to claim 8, wherein said step of determining parameters includes determining number of laths of a security shutter to be covered, and length and width of each area of lath to be covered.

10. A method of producing a covering for a security shutter according to claim 8, wherein said image is divided into several bands and each band is printed separately onto said base layer.

11. A method of producing a covering for a security shutter according to claim 8, wherein said method comprises:
determining a width of gaps between areas of adjacent laths to be covered; and
providing said strips with portions of said image such that the set of strips defines said image with missing portions corresponding to said gaps.

12. A method of producing a covering for a security shutter according to claim 8, wherein said method comprises:
determining a width of gaps between areas of adjacent laths to be covered; and
cutting the laminate to form strips having the width of area to be covered separated by strips having the width of the gap; and
disposing of said strips having the width of said gap.

13. A method of producing a covering for a security shutter according to claim 8, wherein said base layer has a first surface coated with an adhesive layer, and said image is printed on an opposing second surface.

14. A method of producing a covering for a security shutter according to claim 8, wherein said step of covering said base layer includes: pealing a transport layer from said protective layer to reveal an adhesive layer; and fixing said protective layer to said base layer using said adhesive layer.

15. A method of producing a covering for a security shutter according to claim 8, wherein said step of fixing said protective layer to said base layer includes applying heat to said adhesive layer.

16. A method of producing a covering for a security shutter according to claim 8, wherein said protective layer contains means for filtering ultraviolet from incident light to protect said image from fading.

17. A method of advertising, comprising the steps of:
offering advertising space on a security shutter of a building;
obtaining an image relating to a required advertisement;
determining dimensions of said shutter;
printing an image onto a sheet;
cutting said sheet into strips, in dependence upon said dimensions, such that said image is split into portions; and
applying said strips to said shutter to form an advertisement.

18. A method of advertising according to claim 17, wherein said step of printing comprises printing an image onto a sheet of a polymer.

19. A method of advertising according to claim 17, wherein said sheet is provided with an adhesive coating and a release layer, and said step of applying said strips comprises pealing away said release layer and fixing said strips to said shutter using said adhesive coating.

20. A method of advertising according to claim 17, wherein said method of applying said strips to said shutter is performed while said shutter is located on said building, and said shutter is lowered.

21. A method of advertising according to claim 17, wherein said sheet is provided with a transparent protective layer over said image to protect ink printed onto said sheet.
